(19) United States
(12) Patent Application Publication
(10) Pub. No.: US 2025/0389304 A1
(43) Pub. Date: Dec. 25, 2025

(54) SELECTABLE CLUTCH

(71) Applicant: TSUBAKIMOTO CHAIN CO., Osaka (JP)

(72) Inventors: Fumiya Murase, Osaka (JP); Ryota Mase, Osaka (JP)

(73) Assignee: TSUBAKIMOTO CHAIN CO., Osaka (JP)

(21) Appl. No.: 19/314,448

(22) Filed: Aug. 29, 2025

Related U.S. Application Data
(63) Continuation of application No. PCT/JP2024/008695, filed on Mar. 7, 2024.

(30) Foreign Application Priority Data
Mar. 29, 2023 (JP) 2023-053114

(51) Int. Cl. F16D 41/08; F16D 41/07

(52) U.S. Cl. CPC F16D 41/084; F16D 41/07

(57) ABSTRACT

A selectable clutch (100) of the present invention is configured to be able to switch an operation mode by moving an outer ring-side cage ring (120) and an inner ring-side cage ring (130) independently in an axial direction by a cylindrical cam (155) having a cam groove (155) formed on a circumferential surface thereof, wherein the cam groove (155) has a first driven node guide region (L1) including an inclined portion that moves a first driven node (160) connected to the outer ring-side cage ring (120) in the axial direction and a second driven node guide region (L2) including an inclined portion that moves a second driven node connected to the inner ring-side cage ring (130) in the axial direction, one of the regions including an inclined portion that is shifted in phase in the circumferential direction with respect to an inclined portion of the other region.

### TECHNICAL FIELD

The present invention relates to a selectable clutch configured to be able to switch an operation mode.

### BACKGROUND ART

As a selectable clutch, there has been known the one which is configured to be able to switch the operation mode by moving the operation mode switching means in the axial direction to incline a cam functioning as a power transmission member (see, for example, Patent Literature 1).

In the selectable clutch described in Patent Literature 1, three operation modes can be switched, i.e., a bi-directional lock mode in which power can be transmitted in both the normal and reverse directions by inclining only one of a first cam and a second cam different in engagement direction with respect to an outer ring and an inner ring or by inclining both the first cam and the second cam, a one-way lock mode in which power can be transmitted in either the normal or reverse direction, and a bi-directional free mode in which power transmission in both the normal and reverse directions is interrupted.

On the other hand, as a clutch switching mechanism, for example, there is known a mechanism using a cylindrical cam. For example, Patent Literature 2 describes a switching mechanism in a four-wheel drive vehicle drive force distribution device in which an input shaft for inputting power from an engine via an automatic transmission or a manual transmission is connected to a rear wheel output shaft as a main output shaft arranged coaxially via a sub-transmission mechanism comprising a planetary gear mechanism with a sun gear. In this switching mechanism, by rotating a cylindrical shift cam fixed to an output shaft of an actuator for controlling the shift mechanism of the sub-transmission mechanism, the shift pin is axially guided and moved by a shift cam groove formed on an outer periphery of the cylindrical shift cam, and the shift pin is switched between an L position where the shift gear is engaged with the clutch gear and an H position where the sun gear is directly connected to the rear wheel output shaft.

### CITATION LIST

### Patent Literature

Patent Literature 1: Japanese Patent Application Publication No. 2020-190255
Patent Literature 2: Japanese Patent Application Publication No. 2008-128262

### SUMMARY OF INVENTION

### Technical Problem

Thus, the selectable clutch often needs to be configured to be able to switch between four operation modes, a bi-directional lock mode, a normal rotation direction lock mode, a reverse rotation direction lock mode, and a bi-directional free mode. Accordingly, a switching mechanism for switching between the operation modes of the selectable clutch also needs to be configured to allow the selectable clutch to be switched between the four operation modes.

However, the above-described selectable clutch is configured to change the shape of the first cam and the second cam to incline the first cam and the second cam in turn, so that the one-way lock mode can only achieve either the normal rotation direction lock mode and the reverse rotation direction lock mode, and there is a problem that the cam structure itself becomes complicated.

Regarding the switching mechanism, the switching mechanism described in Patent Literature 2 achieves simple linear motion of the driven node between two axial positions by rotation of the cylindrical cam, and even if the selectable clutch is considered to be applied as a drive source for operation mode switching means in the selectable clutch described in Patent Literature 1, it is possible to switch the selectable clutch between four operation modes.

Furthermore, in the switching mechanism described in Patent Literature 2, since the cylindrical cam, the input shaft, and the main output shaft are positioned on different rotational axes, when used as a switching mechanism for a selectable clutch, this means that the size of the selectable clutch in the radial direction increases.

The present invention has been made in view of such circumstances, and an object of the present invention is to provide a selectable clutch capable of smoothly switching operation modes and realizing high functionality by allowing for the switching of the operation modes according to usage.

### Solution to Problem

The present invention solves the foregoing problems by providing a selectable clutch, comprising a switching mechanism for changing an operation mode by forcing one or both of a first cam and a second cam to incline, the first cam and the second cam having different engagement directions with respect to an outer ring and an inner ring and being held by an outer ring-side cage ring and an inner ring-side cage ring provided between the outer ring and the inner ring, wherein the outer ring-side cage ring and the inner ring-side cage ring are provided so as to be movable in an axial direction between a first axial position and a second axial position, the outer ring-side cage ring is configured to be moved between the first axial position and the second axial position so that a posture of the first cam can be changed between an engagement standby posture and an idling posture in which the first cam is inclined to separate from the inner ring or the outer ring, the inner ring-side cage ring is configured to be moved between the first axial position and the second axial position so that the posture of the first cam can be changed between the engagement standby posture and the idling posture in which the first cam is inclined to separate from the inner ring or the outer ring, the switching mechanism includes a cylindrical cam having a cam groove formed on a circumferential surface thereof, and a first driven node and a second driven node coupled to the cylindrical cam, the first driven node being connected to the outer ring-side cage ring, and the second driven node being connected to the inner ring-side cage ring, and the cam groove has a first driven node guide region including an inclined portion that moves the first driven node in the axial direction and a second driven node guide region including an inclined portion that moves the second driven node in the axial direction, and includes an inclined portion formed by shifting one of the first driven node guide region and the second driven node guide region in phase in the circumferential direction with respect to the other region.

### Advantageous Effects of Invention

According to the invention of claim 1, the cam groove formed in the cylindrical cam has a first driven node guide region including an inclined portion for moving the first driven node in the axial direction and a second driven node guide region including an inclined portion for moving the second driven node in the axial direction, and one of the first driven node guide region and the second driven node guide region includes an inclined portion that is shifted in phase in the circumferential direction with respect to an inclined portion of the other region. Accordingly, each of the first driven node and the second driven node can be moved independently in the axial direction. Therefore, by providing a first cam posture control function to the outer ring-side cage ring connected to the first driven node and a second cam posture control function to the inner ring-side cage ring connected to the second driven node, not only is it possible to incline the cam but also the posture of the cam can be changed simply by moving one or both of the outer ring-side cage ring and the inner ring-side cage ring in the axial direction. Accordingly, with a simple configuration, smooth switching of the operation mode is possible, and switching of the operation mode according to usage is possible, whereby high functionality can be realized.

According to the invention of claim 2, the cylindrical cam is configured by forming a cam groove on the circumferential surface of the cylindrical member, and the first driven node is configured by an annular body in which a driven element engaging with the cam groove is provided so as to protrude inwardly from the inner circumferential surface, and the second driven node is configured by an annular body in which a driven element engaging with the cam groove is provided so as to protrude outwardly from the outer circumferential surface. Thus, the cylindrical cam, the first driven node, and the second driven node can be arranged coaxially with the outer ring and the inner ring. Therefore, the size of the selectable clutch in the radial direction can be reduced. Further, since the first driven node guide region and the second driven node guide region can be arranged on the same circumference of the cylindrical cam, the size of the selectable clutch in the axial direction can also be reduced. Furthermore, since the power is transmitted coaxially, bending moment is hardly generated, performance degradation due to deformation can be avoided, and the number of parts can be reduced by having a single shaft, reducing the risk of failure and maintenance opportunities.

According to the invention of claim 3, by forming the first driven node guide region and the second driven node guide region at positions axially apart from each other, said regions having the inclined portions that are shifted in phase in the circumferential direction, each of the first and second driven nodes can be independently moved in the axial direction, and the operation mode can be switched according to usage, thereby realizing high functionality.

According to the invention of claim 4, since the first driven node and the second driven node are prohibited from being rotated with the rotation of the cylindrical cam, the first driven node and the second driven node can reliably be moved in the axial direction by guiding the driven element along the inclined portion of the cam groove, whereby the operation mode can be switched.

According to the invention of claim 5, by restricting the degree of freedom of circumferential movement of the outer ring-side cage ring and the inner ring-side cage ring, “meshing” where the first cam and the second cam are engaged with the outer ring and the inner ring can be avoided when changing the posture of the cam, whereby smooth operation can be achieved to obtain high responsiveness.

According to the invention of claim 6, a simple configuration allows for restriction of the degree of freedom of circumferential movement of the outer ring-side cage ring and the inner ring-side cage ring.

### BRIEF DESCRIPTION OF DRAWINGS

FIG. 1 is an exploded perspective view showing an example of a configuration of a selectable clutch according to a first embodiment of the present invention.

FIG. 2 is a side view of the selectable clutch shown in FIG. 1.

FIG. 3 is a cross-sectional view taken along line A-A in FIG. 2.

FIG. 4 is a cross-sectional view taken along line B-B in FIG. 2.

FIG. 5 is a sectional perspective view taken along a plane including a rotation axis center of the selectable clutch shown in FIG. 1.

FIG. 6A is a perspective view showing a configuration of an outer ring-side cage ring.

FIG. 6B is a partially developed view of the outer ring-side cage ring shown in FIG. 6A.

FIG. 7A is a perspective view showing a configuration of an inner ring-side cage ring.

FIG. 7B is a partially developed view of the inner ring-side cage ring shown in FIG. 7A.

FIG. 8A is a perspective view showing a configuration of a position regulating cage ring.

FIG. 8B is a partially developed view of the position regulating cage ring shown in FIG. 8A.

FIG. 9 is a perspective view showing a configuration of a cylindrical cam.

FIG. 10 is a perspective view showing a configuration of a first driven node.

FIG. 11 is a perspective view showing a configuration of a second driven node.

FIG. 12 is a perspective view showing a configuration of a case.

FIG. 13 is a timing chart for explaining an operation of the cylindrical cam.

FIG. 14 is a schematic diagram schematically showing a state of a first cam and a second cam where the selectable clutch shown in FIG. 1 is in a reverse rotation direction lock mode.

FIG. 15A is a side view showing a state in which the selectable clutch shown in FIG. 1 is in a bi-directional free mode.

FIG. 15B is a schematic diagram schematically showing a state of the first cam and the second cam where the selectable clutch shown in FIG. 1 is in the bi-directional free mode.

FIG. 16A is a side view showing a state in which the selectable clutch shown in FIG. 1 is in a bi-directional lock mode.

FIG. 16B is a schematic diagram schematically showing a state of the first cam and the second cam where the selectable clutch shown in FIG. 1 is in the bi-directional lock mode.

FIG. 17A is a side view showing a state in which the selectable clutch shown in FIG. 1 is in a normal rotation direction lock mode.

FIG. 17B is a schematic diagram schematically showing a state of the first cam and the second cam where the selectable clutch shown in FIG. 1 is in the normal rotation direction lock mode.

FIG. 18 is a developed view showing yet another example of the configuration of the cylindrical cam.

FIG. 19 is a timing chart for explaining an operation of the cylindrical cam.

FIG. 20 is a perspective view showing an example of a configuration of a selectable clutch according to a second embodiment of the present invention.

FIG. 21 is an exploded perspective view of the selectable clutch shown in FIG. 20.

FIG. 22 is a perspective view showing a configuration of an outer ring-side cage ring.

FIG. 23 is a perspective view showing a configuration of an inner ring-side cage ring.

FIG. 24 is a perspective view showing a configuration of the first driven node.

FIG. 25 is a perspective view showing a configuration of the cylindrical cam.

FIG. 26 is a timing chart for explaining an operation of the cylindrical cam.

### DESCRIPTION OF EMBODIMENTS

Examples of the present invention will be described hereinafter with reference to the drawings.

### First Embodiment

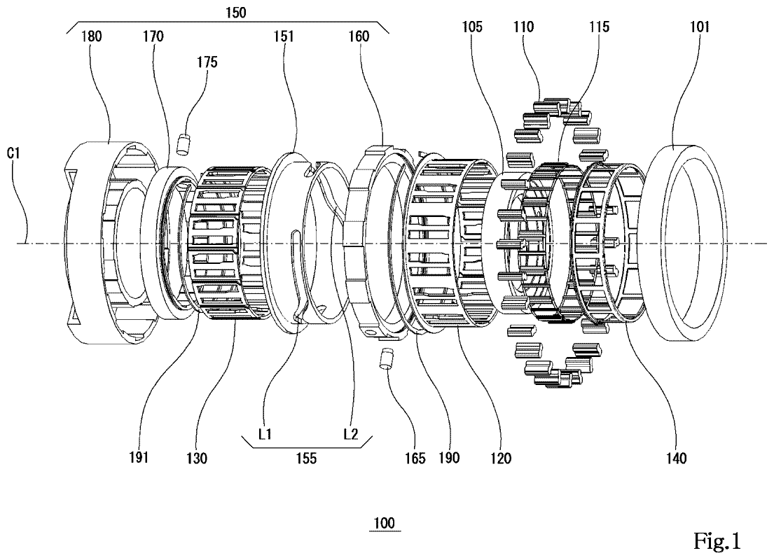

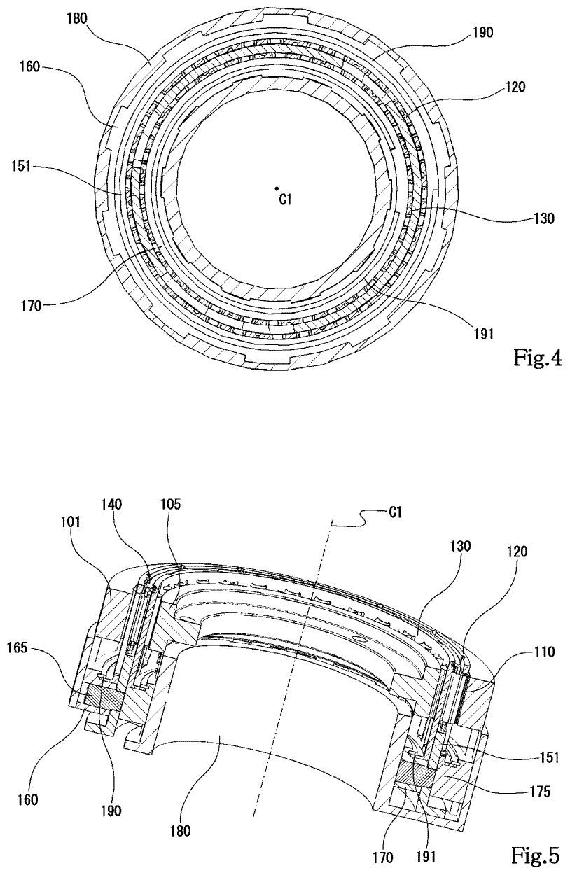

As shown in FIGS. 1 to 5, a selectable clutch 100 according to a first embodiment of the present invention includes: an outer ring 101 and an inner ring 105 provided coaxially so as to be relatively rotatable; a plurality of cams 110 that are arranged in an annular space between an outer ring raceway surface 102 and an inner ring raceway surface 106, at intervals in a circumferential direction, and transmit and interrupt a torque between the outer ring 101 and the inner ring 105; a biasing means 115 for biasing each of the plurality of cams 110 in such a manner as to come into contact with the outer ring 101 and the inner ring 105; an outer ring-side cage ring 120 and an inner ring-side cage ring 130 that are rotatably provided coaxially along with the outer ring 101 or the inner ring 105 between the outer ring 101 and the inner ring 105 and hold each of the plurality of cams 110; a position regulating cage ring 140 that is provided between the outer ring-side cage ring 120 and the inner ring-side cage ring 130 and regulates the degree of freedom of circumferential movement of the outer ring-side cage ring 120 and the inner ring 130; and a switching mechanism 150 that switches an operation mode of the selectable clutch 100. C1 shown in FIGS. 1 to 5 represents a rotation axis center.

Each of the plurality of cams 110 includes a first cam 110a and a second cam 110b having mutually different engagement directions with respect to the outer ring 101 and the inner ring 105.

In the present example, the first cam 110a and the second cam 110b have, for example, an identical outer shape, and the cam 110 in which one end surface thereof is arranged in the front in the axial direction (front side in the direction perpendicular to the page surface in FIG. 3) is used as the first cam 110a, and the cam 110 in which the other end surface thereof is arranged in the front in the axial direction is used as the second cam 110b.

The first cam 110a and the second cam 110b are arranged in, for example, the circumferential direction so as to be alternately arranged at equal intervals.

The arrangement of the first cam 110a and the second cam 110b is not particularly limited, and the first cam 110a and the second cam 110b may not be arranged to alternate in the circumferential direction, and the number of the first cams 110a and the number of the second cams 110b may be different.

The first cam 110a is configured so as to engage with the outer ring 101 and the inner ring 105 by rotating the outer ring 101 in a normal rotation direction (clockwise direction in FIG. 3) or by rotating the inner ring 105 in a reverse rotation direction (counterclockwise direction in FIG. 3).

The second cam 110b is configured so as to engage with the outer ring 101 and the inner ring 105 by rotating the outer ring 101 in the reverse rotation direction or by rotating the inner ring 105 in the normal rotation direction.

The biasing means 115 is composed of a ribbon spring, for example.

The biasing means 115 may be an elastic body capable of biasing each of the first cam 110a and the second cam 110b in such a manner as to come into contact with the outer ring 101 and the inner ring 105, and may use a plurality of leaf springs or torsion springs, for example.

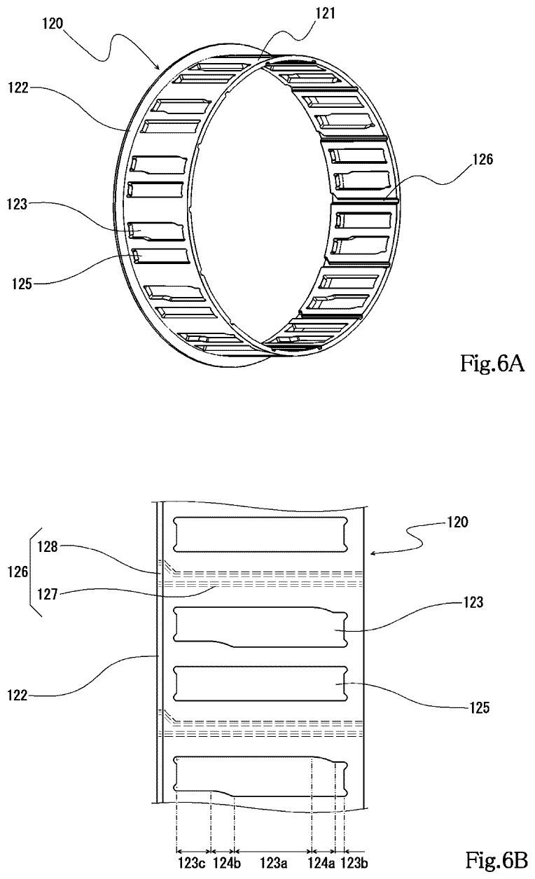

As shown in FIG. 6A, the outer ring-side cage ring 120 includes a cylindrical body portion 121 extending in the axial direction, and an outer flange portion 122 formed so as to protrude radially outward over the entire circumferential periphery thereof at a rear end of the body portion 121. The body portion 121 is provided with a first cam holding portion 123 that receives a head portion of the first cam 110a and holds the first cam 110a, and a second cam holding portion 125 that receives a head portion of the second cam 110b and holds the second cam 110b, the first cam holding portion 123 and the second cam holding portion 125 being arranged alternately in the circumferential direction.

The first cam holding portion 123 of the outer ring-side cage ring 120 is configured to have an opening width variation portion in which an opening width continuously changes in the axial direction.

Specifically, as shown in FIG. 6B, the first cam holding portion 123 includes a guide space portion 123a configured to have a constant opening width in the axial direction, a first posture fixing space portion 123b configured to have a smaller opening width than the guide space portion 123a and be continuous with the axial front side (right side in FIG. 6B) of the guide space portion 123a, and a second posture fixing space portion 123c configured to have a smaller opening width than the guide space portion 123a and be continues to the axial rear side (left side in FIG. 6B) of the guide space portion 123a.

The first posture fixing space portion 123b continues to the guide space portion 123a via a first opening width variation portion 124a that is formed so that the opening width continuously increases toward the axial rear, and the second posture fixing space portion 123c continues to the guide space portion 123a via a second opening width variation portion 124b that is formed so that the opening width continuously increases toward the axial front.

The first opening width variation portion 124a is configured in such a manner that an opening edge of the first cam 110a on the engagement direction (upward direction in FIG. 6B) side protrudes inwardly, and the second opening width variation portion 124b is configured in such a manner that the opening edge of the first cam 110a on an engagement release direction (downward direction in FIG. 6B) side protrudes inwardly.

The second cam holding portion 125 of the outer ring-side cage ring 120 is rectangular and configured to have a constant opening width in the axial direction.

The outer ring-side cage ring 120 is provided so as to be axially movable between a first axial position and a second axial position independently of the rotational operation of the outer ring 101 and the inner ring 105. When positioned in the first axial position, the outer ring-side cage ring 120 is configured to hold the first cam 110a in an engagement standby posture, and when positioned in the second axial position, the outer ring-side cage ring 120 is configured to hold the first cam 110a in an idling posture where the first cam 110a is inclined away from the inner ring 105. Thus, the posture of the first cam 110a can be changed by inclining the first cam 110a while maintaining the posture of the second cam 110b.

Further, since the first cam holding portion 123 of the outer ring-side cage ring 120 is configured not by a simple rectangular opening portion but by an opening window of a different shape whose opening width is narrowed at both axial ends, slight disengagement caused by manufacturing errors or the like can be performed with small thrust, and more operation modes and switching thereof can be realized by properly changing the shape of the opening of the first cam holding portion 123.

The first cam holding portion 123 and an inner surface groove portion 126 extending in the axial direction between the first cam holding portion 123 and the second cam holding portion 125 adjacent thereto in the engagement direction of the first cam 110a, are formed on an inner surface of the body portion 121 in the outer ring-side cage ring 120.

The inner surface groove portion 126 has a guide groove portion 127 linearly extending from an axial rear end edge of the body portion 121 to an axial front end edge, and a slide groove portion 128 continuous with an axial rear end of the guide groove portion 127. The slide groove portion 128 is formed in the circumferential direction so as to extend in the engagement direction of the first cam 110a, and is configured to allow for circumferential movement of an outward protrusion 145 of the position regulating cage ring 140 described later, when the outer ring-side cage ring 120 is at a position where the first cam 110a is in the engagement standby posture.

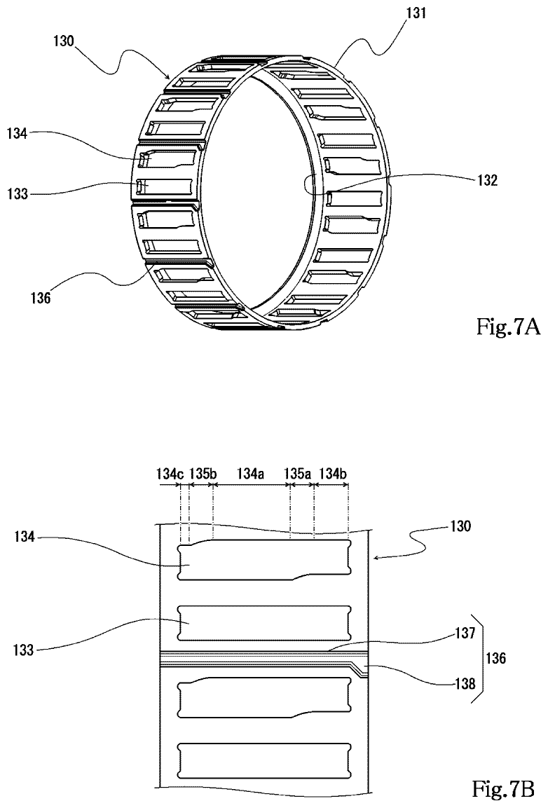

As shown in FIG. 7A, the inner ring-side cage ring 130 includes a cylindrical body portion 131 extending axially, and an inner flange portion 132 formed so as to protrude radially inward over the entire circumferential periphery thereof at an axial rear end of the body portion 131.

The body portion 131 is provided with a first cam holding portion 133 that receives a leg portion of the first cam 110a and holds the first cam 110a, and a second cam holding portion 134 that receives a leg portion of the second cam 110b and holds the second cam 110b, the first cam holding portion 133 and the second cam holding portion 134 being arranged alternately in the circumferential direction.

The first cam holding portion 133 of the inner ring-side cage ring 130 is rectangular and configured to have a constant opening width in the axial direction, as shown in FIG. 7B.

The second cam holding portion 134 of the inner ring-side cage ring 130 is configured to have an opening width variation portion in which an opening width continuously changes in the axial direction.

Specifically, the second cam holding portion 134 includes a guide space portion 134a configured to have a constant opening width in the axial direction, a first posture fixing space portion 134b configured to have a smaller opening width than the guide space portion 134a and be continuous with the axial front side (right side in FIG. 7B) of the guide space portion 134a, and a second posture fixing space portion 134c configured to have a smaller opening width than the guide space portion 134a and be continues to the axial rear side (left side in FIG. 7B) of the guide space portion 134a.

The first posture fixing space portion 134b continues to the guide space portion 134a via a first opening width variation portion 135a that is formed so that the opening width continuously increases toward the axial rear, and the second posture fixing space portion 134c continues to the guide space portion 134a via a second opening width variation portion 135b that is formed so that the opening width continuously increases toward the axial front.

The first opening width variation portion 135a is configured in such a manner that an opening edge of the second cam 110b on the engagement direction (downward direction in FIG. 7B) side protrudes inwardly, and the second opening width variation portion 135b is configured in such a manner that the opening edge of the second cam 110b on an engagement release direction (upward direction in FIG. 7B) side protrudes inwardly.

The inner ring-side cage ring 130 is provided so as to be axially movable between a first axial position and a second axial position independently of the rotational operation of the outer ring 101 and the inner ring 105. When positioned in the first axial position, the inner ring-side cage ring 130 is configured to hold the second cam 110b in an engagement standby posture, and when positioned in the second axial position, the inner ring-side cage ring 130 is configured to hold the second cam 110b in an idling posture where the second cam 110b is inclined away from the inner ring 105. Thus, the posture of the second cam 110b can be changed by inclining the second cam 110b while maintaining the posture of the first cam 110a.

Further, since the second cam holding portion 134 of the inner ring-side cage ring 130 is configured not by a simple rectangular opening portion but by an opening window of a different shape whose opening width is narrowed at both axial ends, slight disengagement caused by manufacturing errors or the like can be performed with small thrust, and more operation modes and switching thereof can be realized by properly changing the shape of the opening of the second cam holding portion 134.

The second cam holding portion 134 and an outer surface groove portion 136 extending in the axial direction between the second cam holding portion 134 and the first cam holding portion 133 adjacent thereto in the engagement release direction of the second cam 110b, are formed on an outer surface of the body portion 131 in the inner ring-side cage ring 130.

The outer surface groove portion 136 has a guide groove portion 137 linearly extending from an axial front end edge of the body portion 131 to an axial rear end edge, and a slide groove portion 138 continuous with an axial front end of the guide groove portion 137. The slide groove portion 138 is formed in the circumferential direction so as to extend in the engagement direction of the second cam 110b, and is configured to allow for circumferential movement of an inward protrusion 146 of the position regulating cage ring 140 described later, when the inner ring-side cage ring 130 is at a position where the second cam 110b is in the engagement standby posture.

Thus, as described above, the selectable clutch 100 of the present example is provided with the position regulating cage ring 140 for regulating the degrees of freedom of circumferential movements of the outer ring-side cage ring 120 and the inner ring-side cage ring 130. Thus, the degrees of freedom of circumferential movements of the outer ring-side cage ring 120 and the inner ring-side cage ring 130 with respect to the position regulating cage ring 140 can be adjusted to a proper degree of freedom corresponding to each operation mode, and the first cam 110a and the second cam 110b can be held in proper postures.

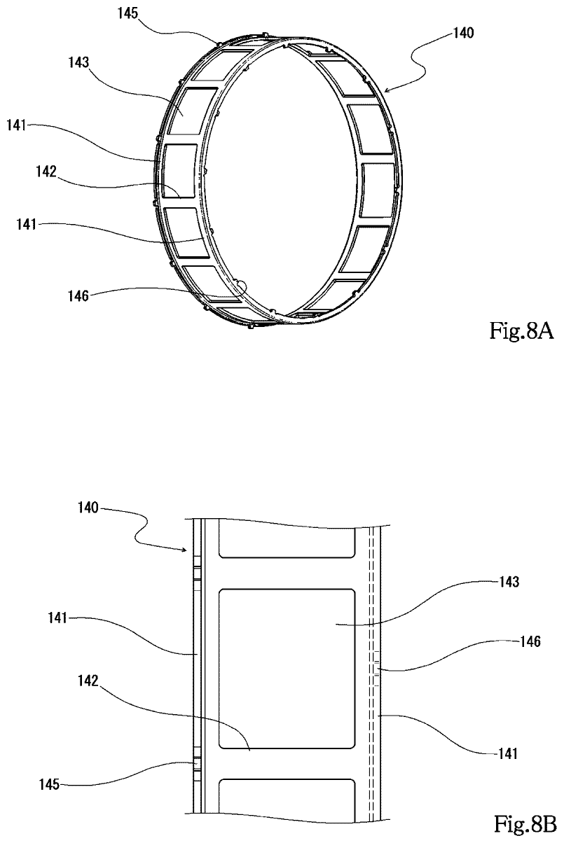

As shown in FIGS. 8A and 8B, the position regulating cage ring 140 comprises a pair of annular portions 141 arranged side by side in the axial direction, and a plurality of connecting portions 142 for connecting the annular portions 141 in the axial direction at predetermined intervals, and a pocket portion 143 capable of housing the first cam 110a and the second cam 110b one by one is configured by a space between the adjacent connecting portions 142. Pocket portions 143 are provided at equal intervals along the circumferential direction.

The position regulating cage ring 140 has the outward protrusion 145 that is provided at an axial front end to protrude radially outward and is slidably brought into engagement with the inner surface groove portion 126 of the outer ring-side cage ring 120, and the inward protrusion 146 that is provided at an axial rear end to protrude radially inward and is slidably brought into engagement with the outer surface groove portion 136 of the inner ring-side cage ring 130.

The switching mechanism 150 includes a cylindrical cam 151, a first driven node 160 and a second driven node 170 coupled to the cylindrical cam 151, and a case 180 housing the first driven node 160 and the second driven node 170.

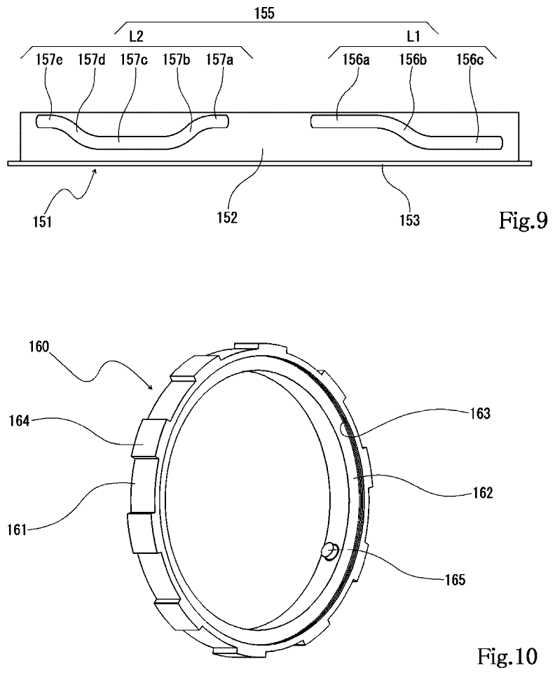

As shown in FIG. 9, in the cylindrical cam 151 in the present embodiment, a cam groove 155 is formed on the circumferential surface of a cylindrical member, and the cylindrical cam 151 has a cylindrical shaft portion 152 and an outer flange portion 153 that is formed at an axial rear end of the shaft portion 152 so as to extend radially outwardly over the entire circumferential periphery thereof and transmits power from a drive source as appropriate.

The cylindrical cam 151 is positioned on the rotation axis center C1, with the shaft portion 152 inserted between the outer ring-side cage ring 120 and the inner ring-side cage ring 130, as shown in FIG. 5, thereby reducing the size of the selectable clutch 100 in the radial direction is reduced. Furthermore, since power is transmitted coaxially, bending moment is hardly generated, performance degradation due to deformation can be avoided, and the number of parts can be reduced by having a single shaft, reducing the risk of failure and maintenance opportunities.

The cam groove 155 has a first driven node guide region L1 including an inclined portion engaged with a first driven element 165 of the first driven node 160 and moving the first driven node 160 in the axial direction, and a second driven node guide region L2 including an inclined portion engaged with a second driven element 175 of the second driven node 170 and moving the second driven node 170 in the axial direction.

The first driven node guide region L1 and the second driven node guide region L2 are arranged on the same circumference of the cylindrical cam 151 at positions facing each other across the rotation axis center C1, and thus, the size of the selectable clutch 100 in the axial direction is also reduced.

The first driven node guide region L1 has a first linear portion 156a formed so as to extend circumferentially at an axial front side portion, a first inclined portion 156b formed so as to extend inclined toward the axial rear side and continuous with the first linear portion 156a, and a second linear portion 156c formed so as to extend circumferentially at an axial rear side portion and continuous with the first inclined portion 156b.

The second driven node guide region L2 includes a first linear portion 157a formed so as to extend circumferentially at an axial front side portion, a first inclined portion 157b formed so as to extend inclined toward the axial rear side and continuous with the first linear portion 157a, a second linear portion 157c formed so as to extend circumferentially at an axial rear side portion and continuous with the first inclined portion 157b, a second inclined portion 157d formed so as to extend inclined toward the axial front side and continuous with the second linear portion 157c, and a third linear portion 157e formed so as to extend circumferentially at the axial front side portion and continuous with the second inclined portion 157d.

As shown in FIG. 10, the first driven node 160 is an annular body and includes an annular base body portion 161 and the first driven element 165 engaged with the cam groove 155 of the cylindrical cam 151.

A recess 162 configured to allow the outer flange portion 122 of the outer ring-side cage ring 120 to be arranged is formed on a front end surface of the base body portion 161. In a state where a rear surface of the outer flange portion 122 is in contact with a bottom surface of the recess 162, a C-shaped snap ring 190 formed by cutting out a part of an annular plate is externally fitted to an inner circumferential surface of a circumferential wall portion 163 defining the recess 162. Accordingly, the outer ring-side cage ring 120 and the first driven node 160 are connected.

Further, on an outer circumferential surface of the base body portion 161, a plurality of outer teeth 164 are formed so as to be aligned at predetermined intervals in the circumferential direction, and a driven element insertion hole extending so as to penetrate the base body portion 161 in a thickness direction thereof is formed.

The first driven element 165 is inserted into the driven element insertion hole so that a distal end protrudes radially inwardly from an inner circumferential surface of the base body portion 161.

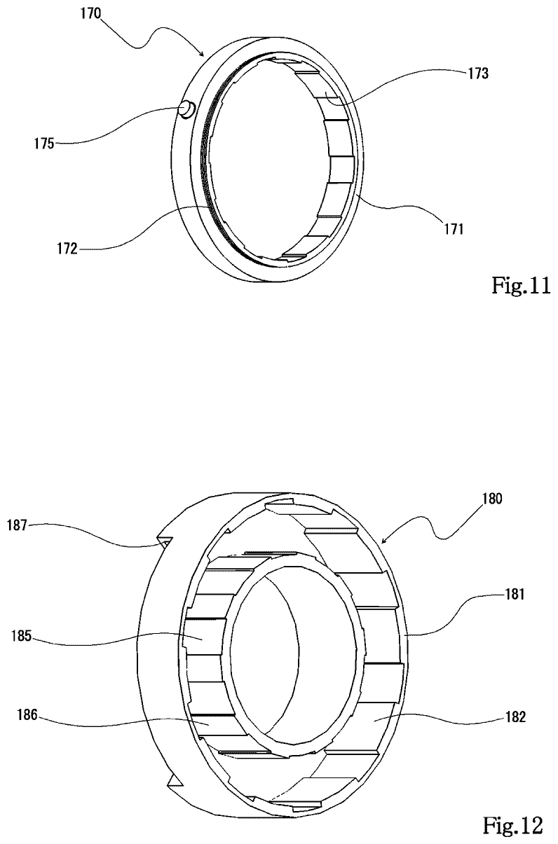

As shown in FIG. 11, the second driven node 170 is an annular body and includes an annular base body portion 171 and the second driven element 175 engaged with the cam groove 155 of the cylindrical cam 151.

A thin cylindrical extension portion 172 is formed on a front end surface of the base body portion 171 in such a manner that an inner circumferential surface of the extension portion 172 continues to an inner circumferential surface of the base body portion 171. In a state where a rear surface of the inner flange portion 132 in the inner ring-side cage ring 130 is in contact with the front end surface of the base body portion 171, a C-shaped snap ring 191 formed by cutting out a part of an annular plate is externally fitted to an outer circumferential surface of the extension portion 172. Accordingly, the inner ring-side cage ring 130 and the second driven node 170 are connected.

Further, on an inner circumferential surface of the base body portion 171, a plurality of inner teeth 173 are formed so as to be aligned at predetermined intervals in the circumferential direction, and a driven element insertion hole extending so as to penetrate the base body portion 171 in a thickness direction thereof is formed.

The second driven element 175 is inserted into the driven element insertion hole so that a distal end protrudes radially outward from an outer circumferential surface of the base body portion 171.

As shown in FIG. 12, the case 180 is formed in a double cylindrical shape with a closed rear end, and has a detent portion that prohibits the first driven node 160 and the second driven node 170 from rotating together with the cylindrical cam 151.

The detent portion is composed of an inner tooth 182 formed on an inner circumferential surface of an outer cylindrical portion 181 of the case 180 and an outer tooth 186 formed on an outer circumferential surface of an inner cylindrical portion 185. The inner tooth 182 is spline-coupled to an outer tooth 164 of the first driven node 160 and the outer tooth 186 is spline-coupled to an inner tooth 173 of the second driven node 170, thereby prohibiting the first driven node 160 and the second driven node 170 from rotating as the cylindrical cam 151 rotates. Therefore, the first driven element 165 and the second driven element 175 are guided along the inclined portion of the cam groove 155, thereby reliably moving the first driven node 160 and the second driven node 170 in the axial direction to switch the operation mode of the selectable clutch 100. Although the detent portion according to the present embodiment is configured to spline-couple the first driven node 160 and the second driven node 170 to the case 180, but may be configured to couple the first driven node 160 and the second driven node 170 to the case 180 by key coupling or other methods.

The outer cylindrical portion 181 is formed with a notch 187 for exposing a portion of the outer flange portion 153 of the cylindrical cam 151 to the outside, and can transmit power from a drive source to the cylindrical cam 151 as appropriate.

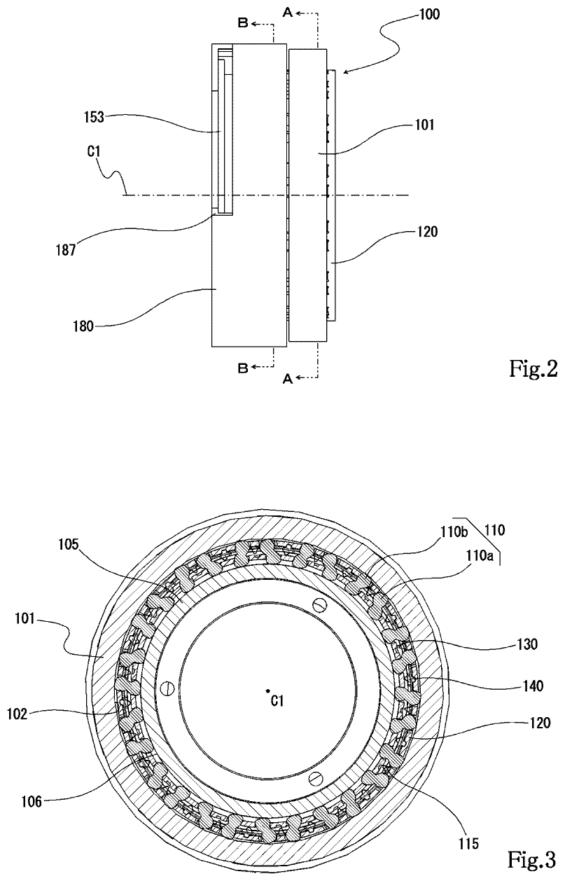

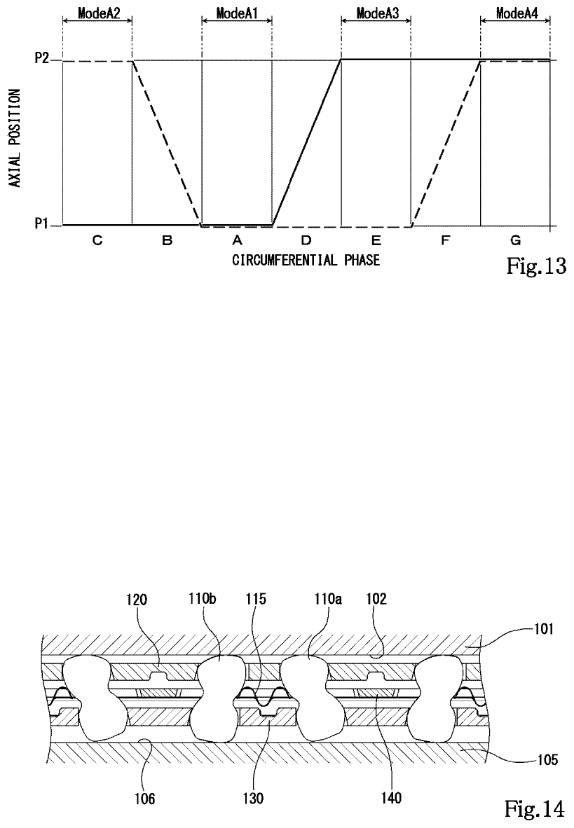

In this switching mechanism 150, when both the outer ring-side cage ring 120 and the inner ring-side cage ring 130 are located at a first axial position P1 (see FIG. 2) as shown in FIG. 13, the first driven element 165 of the first driven node 160 and the second driven element 175 of the second driven node 170 are located at the second linear portion 156c of the first driven node guide region L1 and the second linear portion 157c of the second driven node guide region L2, respectively (region A in FIG. 13). The solid broken line shown in FIG. 13 indicates the relationship between the circumferential phase of the first driven element 165 relative to the cam groove 155 and the axial position of the outer ring-side cage ring 120, and the dashed broken line indicates the relationship between the circumferential phase of the second driven element 175 relative to the cam groove 155 and the axial position of the inner ring-side cage ring 130.

Here, as shown in FIG. 14, the first cam 110a maintains an idling posture in which an inner ring-side engaging surface is inclined so as to separate from an inner ring raceway surface 106, and the second cam 110b maintains an engagement standby posture in contact with the outer ring 101 and the inner ring 105 so that the second cam 110b immediately starts engagement with the outer ring 101 and the inner ring 105 by torque acting on the outer ring 101 or the inner ring 105. Accordingly, the selectable clutch 100 is in a reverse rotation direction lock mode (ModeA1) for inhibiting relative rotation of the inner ring 105 in the reverse rotation direction relative to the outer ring 101.

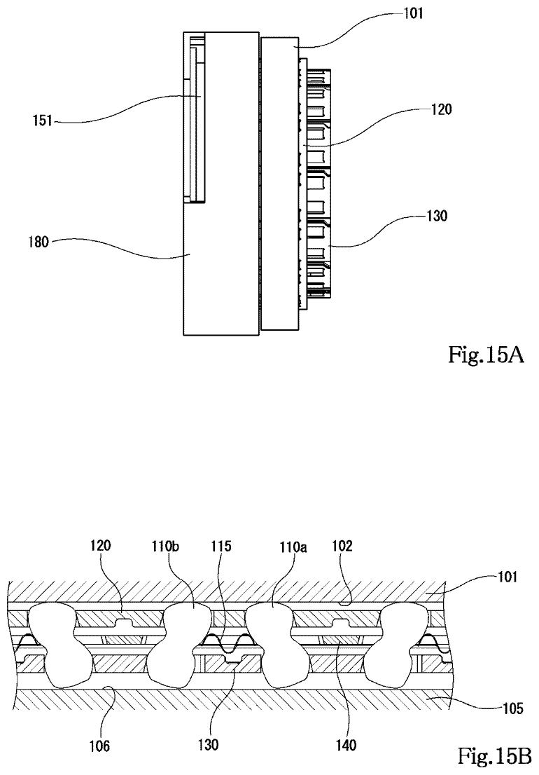

When the cylindrical cam 151 is rotated in the normal rotation direction, the first driven element 165 is guided along the second linear portion 156c of the first driven node guide region L1, and the outer ring-side cage ring 120 maintains a state of being positioned at the first axial position P1 (region B, region C in FIG. 13). On the other hand, the second driven element 175 is guided along the first inclined portion 157b of the second driven node guide region L2, and the second driven node 170 and the inner ring-side cage ring 130 connected thereto move axially forward (region B in FIG. 13). Thereafter, as the second driven element 175 is guided along the first linear portion 157a, the inner ring-side cage ring 130 is positioned at a second axial position P2, as shown in FIG. 15A (region C in FIG. 13).

At this moment, as shown in FIG. 15B, the leg portion of the second cam 110b is pressed by the action of the second opening width variation portion 135b in the second cam holding portion 134 of the inner ring-side cage ring 130, and thereby the second cam 110b is inclined in the engagement release direction. Since the first cam holding portion 133 of the inner ring-side cage ring 130 is formed in a rectangular shape with a constant opening width in the axial direction, the posture of the first cam 110a keeps an idling posture.

Thus, the operation mode of the selectable clutch 100 is switched from the reverse rotation direction lock mode (ModeA1) to a bi-directional free mode (ModeA2) that allows for relative rotation of the outer ring 101 and the inner ring 105 in both normal and reverse rotation directions.

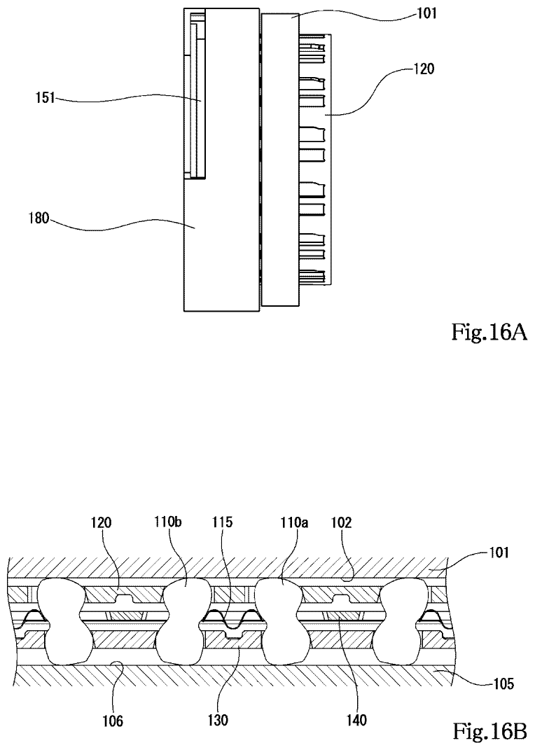

Also, when the cylindrical cam 151 is rotated in the reverse rotation direction, the first driven element 165 is guided along the first inclined portion 156b of the first driven node guide region L1, and the first driven node 160 and the outer ring-side cage ring 120 connected thereto move axially forward (region D in FIG. 13). Thereafter, as the first driven element 165 is guided along the first linear portion 156a, the outer ring-side cage ring 120 is positioned at the second axial position P2, as shown in FIG. 16A (region E in FIG. 13). On the other hand, the second driven element 175 is guided along the second linear portion 157c of the second driven node guide region L2, and the inner ring-side cage ring 130 maintain the state of being positioned at the first axial position P1 (region D in FIG. 13, region E).

At this moment, as shown in FIG. 16B, the head portion of the first cam 110a is pressed by the action of the second opening width variation portion 124b in the first cam holding portion 123 of the outer ring-side cage ring 120, and thereby the first cam 110a is inclined in the engagement direction. Since the second cam holding portion 125 in the outer ring-side cage ring 120 is formed in a rectangular shape with a constant opening width in the axial direction, the posture of the second cam 110b keeps the engagement standby posture.

Thus, the operation mode of the selectable clutch 100 is switched from the reverse rotation direction lock mode (ModeA1) to a bi-directional lock mode (ModeA3) that inhibits relative rotation of the outer ring 101 and the inner ring 105 in both normal and reverse rotation directions.

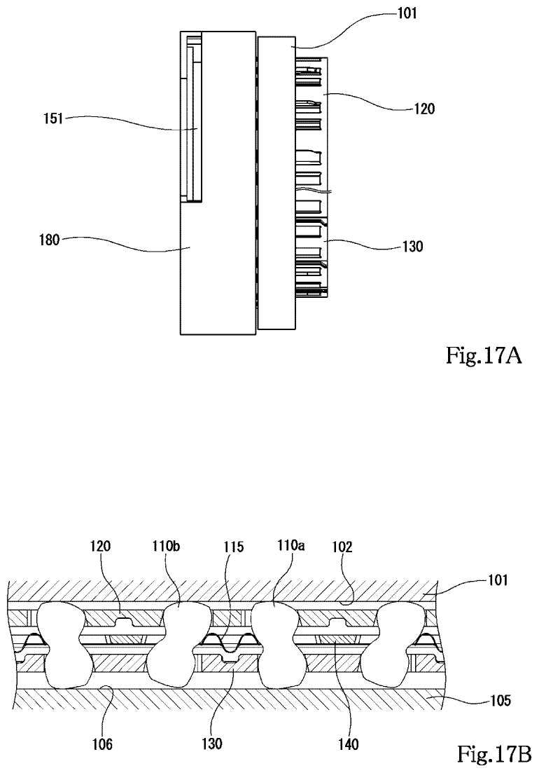

When the cylindrical cam 151 is further rotated in the reverse rotation direction, the first driven element 165 is guided along the first linear portion 156a of the first driven node guide region L1, and the outer ring-side cage ring 120 maintains a state of being positioned at the second axial position P2 (region F, region G in FIG. 13). On the other hand, the second driven element 175 is guided along the second inclined portion 157d of the second driven node guide region L2, and the second driven node 170 and the inner ring-side cage ring 130 connected thereto move axially forward (region F in FIG. 13). Thereafter, as the second driven element 175 is guided along the third linear portion 157e, the inner ring-side cage ring 130 is positioned at the second axial position P2, as shown in FIG. 17A (region G in FIG. 13).

At this moment, as shown in FIG. 17B, the leg portion of the second cam 110b is pressed by the action of the second opening width variation portion 135b in the second cam holding portion 134 of the inner ring-side cage ring 130, and thereby the second cam 110b is inclined in the engagement release direction. Since the first cam holding portion 133 of the inner ring-side cage ring 130 is formed in a rectangular shape with a constant opening width in the axial direction, the posture of the first cam 110a is held in the engagement standby posture.

Thus, the operation mode of the selectable clutch 100 is switched from the bi-directional lock mode (ModeA3) to a normal rotation direction lock mode (ModeA4) for inhibiting relative rotation of the inner ring 105 in the normal rotation direction relative to the outer ring 101.

Thus, according to the selectable clutch 100 described above, the cam groove 155 formed in the cylindrical cam 151 has the first driven node guide region L1 including the first inclined portion 156b for moving the first driven node 160 in the axial direction, and the second driven node guide region L2 including the first inclined portion 157b and the second inclined portion 157d for moving the second driven node 170 in the axial direction, and one of the first driven node guide region L1 and the second driven node guide region L2 includes an inclined portion that is shifted in phase in the circumferential direction with respect to the inclined portion of the other region. Accordingly, each of the first driven node 160 and the second driven node 170 can be moved independently in the axial direction. Therefore, the cam 110 can be inclined and the changed posture of the cam 110 can be held simply by moving one or both of the outer ring-side cage ring 120 and the inner ring-side cage ring 130 in the axial direction by providing the outer ring-side cage ring 120 connected to the first driven node 160 with the posture control function of the first cam 110a and providing the inner ring-side cage ring 130 connected to the second driven node 170 with the posture control function of the second cam 110b. Accordingly, with a simple configuration, smooth switching of the operation mode is possible, and switching of the operation mode according to usage is possible, whereby high functionality can be realized.

Although the selectable clutch configured to be able to switch between four operation modes has been described above, the selectable switch may be configured to be able to switch between three operation modes of, for example, the bi-directional lock mode, the bi-directional free mode, and the normal rotation direction lock mode or the reverse rotation direction lock mode.

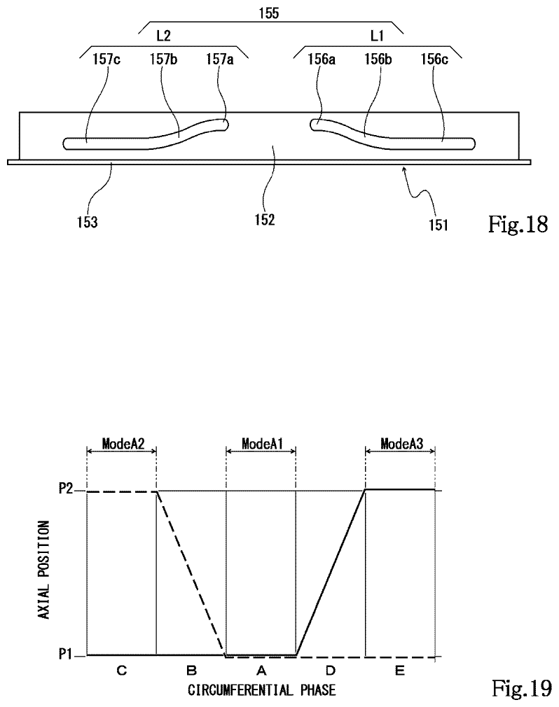

In the cylindrical cam 151 constituting the switching mechanism in the selectable clutch having such a configuration, as shown in FIG. 18, the first driven node guide region L1 of the cam groove 155 includes the first linear portion 156a formed so as to extend circumferentially at the axial front side portion, the first inclined portion 156b formed so as to extend inclined toward the axial rear side and continuous with the first linear portion 156a, and the second linear portion 156c formed so as to extend circumferentially at the axial rear side portion and continuous with the first inclined portion 156b.

The second driven node guide region L2 in the cam groove 155 has the first linear portion 157a formed so as to extend in the circumferential direction at the axial front side portion, the first inclined portion 157b formed so as to extend inclined toward the axial rear side and continuous with the first linear portion 157a, and the second linear portion 157c formed so as to extend in the circumferential direction at the axial rear side portion and continuous with the first inclined portion 157b.

The first inclined portion 156b in the first driven node guide region L1 and the first inclined portion 157b in the second driven node guide region L2 are formed with phases shifted in the circumferential direction from each other.

In the switching mechanism with such a cylindrical cam 151, when both the outer ring-side cage ring 120 and the inner ring-side cage ring 130 are positioned at the first axial position P1 as shown in FIG. 19, the first driven element 165 of the first driven node 160 and the second driven element 175 of the second driven node 170 are positioned at the second linear portion 156c of the first driven node guide region L1 and the second linear portion 157c of the second driven node guide region L2 (region A in FIG. 19). At this time, the first cam 110a is held in the idling posture and the second cam 110b is held in the engagement standby posture, and therefore the operation mode of the selectable clutch 100 is the reverse rotation direction lock mode (ModeA1) for inhibiting relative rotation of the inner ring 120 in the reverse rotation direction relative to the outer ring 110.

When the cylindrical cam 151 is rotated in the normal rotation direction, the first driven element 165 is guided along the second linear portion 156c of the first driven node guide region L1, and the outer ring-side cage ring 130 maintains the state of being positioned at the first axial position P1 (region B, region C in FIG. 19). On the other hand, the second driven element 175 is guided along the first inclined portion 157b of the second driven node guide region L2, and the second driven node 170 and the inner ring-side cage ring 130 connected thereto move axially forward (region B in FIG. 19). Thereafter, the second driven element 175 is guided along the first linear portion 157a, whereby the inner ring-side cage ring 130 is positioned at the second axial position P2 (region C in FIG. 13). Accordingly, the first cam 110a is held in the idling posture, and the second cam 110b is inclined from the engagement standby posture to the idling posture. Thus, the operation mode of the selectable clutch 100 is switched from the reverse rotation direction lock mode (ModeA1) to the bi-directional free mode (ModeA2) that allows for relative rotation of the outer ring 101 and the inner ring 105 in both the normal and reverse rotation directions.

When the cylindrical cam 151 is rotated in the reverse rotation direction, the first driven element 165 is guided along the first inclined portion 156b of the first driven node guide region L1, and the first driven node 160 and the outer ring-side cage ring 120 connected thereto move axially forward (region D in FIG. 19). Thereafter, the first driven element 165 is guided along the first linear portion 156a, whereby the outer ring-side cage ring 120 is positioned at the second axial position P2 (region E in FIG. 19). On the other hand, the second driven element 175 is guided along the second linear portion 157c of the second driven node guide region L2, and the inner ring-side cage ring 130 maintains the state of being positioned at the first axial position P1 (region D, region E in FIG. 19). Accordingly, the first cam 110a is inclined from the idling posture to the engagement standby posture, and the second cam 110b is held in the engagement standby posture. Thus, the operation mode of the selectable clutch 100 is switched from the reverse rotation direction lock mode (ModeA1) to the bi-directional lock mode (ModeA3) that inhibits relative rotation of the outer ring 101 and the inner ring 105 in both the normal and reverse rotation directions.

### Second Embodiment

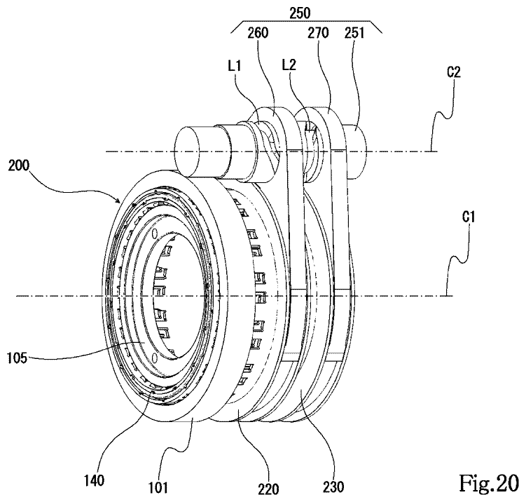

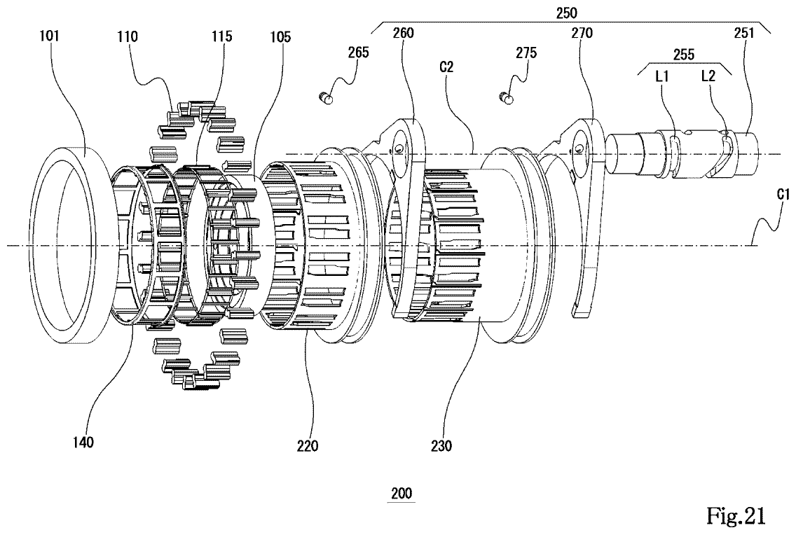

FIG. 20 is a perspective view showing an example of a configuration of a selectable clutch according to a second embodiment of the present invention, and FIG. 21 is an exploded perspective view of the selectable clutch shown in FIG. 20.

A selectable clutch 200 according to the second embodiment has substantially the same configuration as the selectable clutch 100 according to the first embodiment except that the configuration of the switching mechanism is different, and for convenience, the same reference numerals are assigned to the same constituent members as those of the selectable clutch 100 according to the first embodiment, and description thereof will be omitted accordingly.

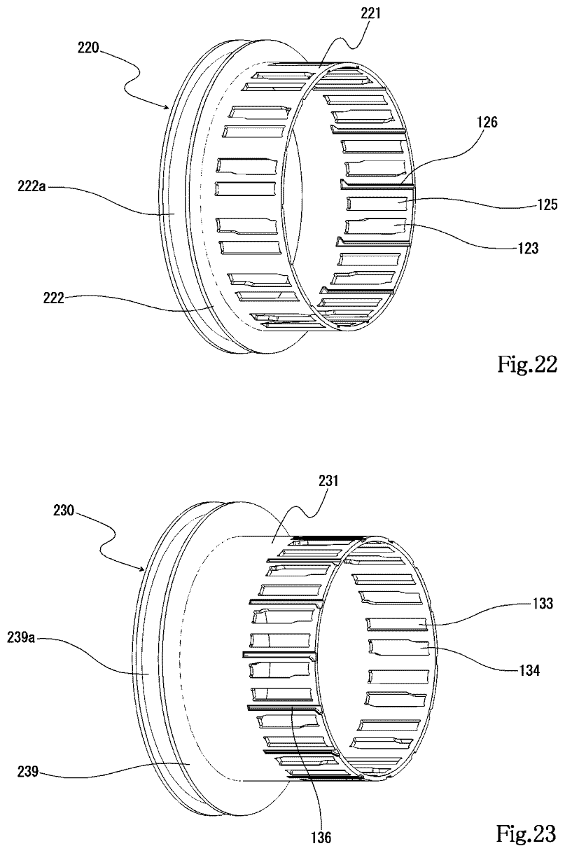

As shown in FIG. 22 as well, an outer ring-side cage ring 220 of the present embodiment is formed such that the axial dimension of a body portion 221 is larger than that of the body portion 121 of the outer ring-side cage ring 120 of the selectable clutch 100 according to the first embodiment. The first cam holding portion 123, the second cam holding portion 125, and the inner surface groove portion 126 are formed at an axial front side portion of the body portion 221, and a first driven node mounting portion is formed on an axial rear end of the body portion 221.

The first driven node mounting portion is configured by forming a recessed groove 222a extending over the entire circumference in the circumferential direction on an outer circumferential surface of an outer flange portion 222 provided at a rear end of the body portion 221.

As shown in FIG. 23 as well, an inner ring-side cage ring 230 in the present embodiment has the first cam holding portion 133, the second cam holding portion 134, and the outer surface groove portion 136 formed in an axially front side portion of a body portion 231, and a second driven node mounting portion is formed at an axial rear end.

The second driven node mounting portion is configured by forming a recessed groove 239a extending over the entire circumference in the circumferential direction on an outer circumferential surface of an outer flange portion 239 provided at a rear end of the body portion 231.

The body portion 231 is formed to have an axial dimension larger than that of the body portion 221 of the outer ring-side cage ring 220 so that, in an assembled state, a rear end side portion protrudes rearward from a rear end surface of the outer ring-side cage ring 220. Thus, the second driven node mounting portion of the inner ring-side cage ring 230 is positioned away from the first driven node mounting portion of the outer ring-side cage ring 220 toward the axial rear side.

A first driven node 260 and a second driven node 270 in a switching mechanism 250 of the present embodiment share the same configuration, and the description of the configuration of the second driven node 270 is omitted.

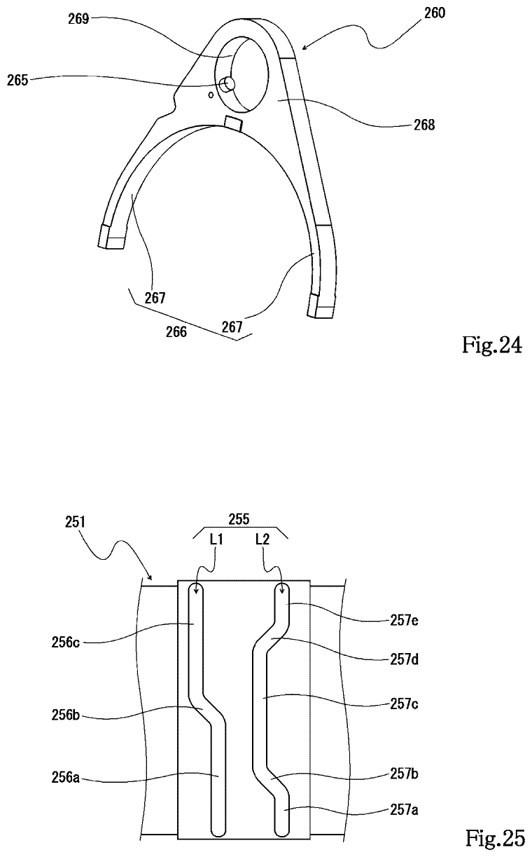

The first driven node 260 has an engaging portion 266 and a bearing portion 268, as shown in FIG. 24 as well.

The engaging portion 266 is formed in a C-shape with a portion of an annular ring notched, has a pair of arm portions 267, and is elastically deformed so as to expand, thereby engaging with the first driven node mounting portion of the outer ring-side cage ring 220. The engaging portion of the second driven node 270 is configured to be engaged with the second driven node mounting portion of the inner ring-side cage ring 230.

The bearing portion 268 is formed continuously to the engaging portion 266 so as to extend radially outward with respect to the center of the shape of the engaging portion 266, and has a cylindrical cam insertion hole 269 configured in such a manner that a cylindrical cam 251 is rotatably inserted therethrough. In the bearing portion 268, a driven element insertion hole is formed so as to open to the inner circumferential surface of the cylindrical cam insertion hole 269, and in the driven element insertion hole, a rod-shaped first driven element 265 is arranged so that its distal end protrudes inwardly from the inner circumferential surface of the cylindrical cam insertion hole 269. In the second driven node 270, a rod-shaped second driven element 275 is arranged so that its distal end protrudes inwardly from the inner circumferential surface of the cylindrical cam insertion hole.

The cylindrical cam 251 in the switching mechanism 250 of the present embodiment has a cam groove 255 formed on the circumferential surface of a cylindrical member. As shown in FIG. 20, the cylindrical cam 251 is inserted through each of the cylindrical cam insertion hole 269 of the first driven node 260 connected to the outer ring-side cage ring 220 and the cylindrical cam insertion hole of the second driven node 270 connected to the inner ring-side cage ring 230, and is coupled to the first driven node 260 and the second driven node 270 by the first driven element 265 of the first driven node 260 and the second driven element 275 of the second driven node 270 coming into engagement with the cam groove 255, and is arranged so as to be rotatable forward and backward around a rotational drive shaft C2 extending in parallel with the rotation axis center C1.

As also shown in FIG. 25 as well, the cam groove 255 has a first driven node guide region L1 including an inclined portion engaged with the first driven element 265 of the first driven node 260 and moving the first driven node 260 in the axial direction, and a second driven node guide region L2 including an inclined portion engaged with the second driven element 275 of the second driven node 270 and moving the second driven node 270 in the axial direction. In the present embodiment, the second driven node guide region L2 is formed at a position spaced apart from the first driven node guide region L1 axially rearward.

The first driven node guide region L1 has a first linear portion 256a formed so as to extend in the circumferential direction, a first inclined portion 256b formed so as to extend inclined toward the axial front side and continuous with the first linear portion 256a, and a second linear portion 256c formed so as to extend in the circumferential direction and continuous with the first inclined portion 256b.

The second driven node guide region L2 includes a first linear portion 257a formed so as to extend in the circumferential direction, a first inclined portion 257b formed so as to extend inclined toward the axial front side and continuous with the first linear portion 257a, a second linear portion 257c formed so as to extend in the circumferential direction and continuous with the first inclined portion 257b, a second inclined portion 257d formed so as to extend inclined toward the axial rear side and continuous with the second linear portion 257c, and a third linear portion 257e formed so as to extend in the circumferential direction at the axial rear side portion and continuous with the second inclined portion 257d.

In the cam groove 255, the first inclined portion 256b in the first driven node guide region L1 and the first inclined portion 257b and the second inclined portion 257d in the second driven node guide region L2 are formed with phases shifted in the circumferential direction from each other. Accordingly, each of the first driven node 260 and the second driven node 270 can be moved independently in the axial direction.

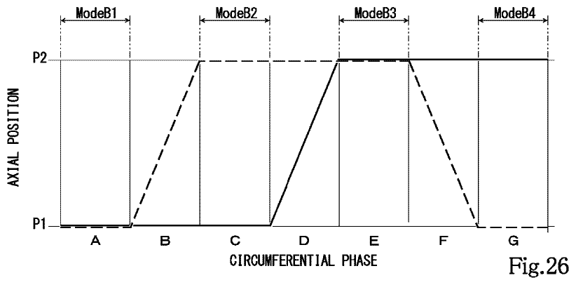

As shown in FIG. 26, in this switching mechanism 250, when both the outer ring-side cage ring 220 and the inner ring-side cage ring 230 are located at the first axial position P1 (see FIG. 20), the first driven element 265 of the first driven node 260 and the second driven element 275 of the second driven node 270 are positioned at the first linear portion 256a of the first driven node guide region L1 and the first linear portion 257a of the second driven node guide region L2, respectively (region A in FIG. 26). The solid broken line shown in FIG. 26 indicates the relationship between the circumferential phase of the first driven element 265 relative to the cam groove 255 and the axial position of the outer ring-side cage ring 220, and the dashed broken line indicates the relationship between the circumferential phase of the second driven element 275 relative to the cam groove 255 and the axial position of the inner ring-side cage ring 230.

Here, the first cam 110a maintains an idling posture in which an inner ring-side engaging surface is inclined so as to separate from the inner ring raceway surface 106, and the second cam 110b maintains an engagement standby state in contact with the outer ring 101 and the inner ring 105 so that the second cam 110b immediately starts engagement with the outer ring 101 and the inner ring 105 by torque acting on the outer ring 101 or the inner ring 105. Accordingly, the selectable clutch 200 is in a reverse rotation direction lock mode (ModeB1) for inhibiting relative rotation of the inner ring 105 in the reverse rotation direction relative to the outer ring 101.

When the cylindrical cam 251 is rotated in a clockwise direction (normal rotation direction) when viewed from the axial front side, the first driven element 265 is guided along the first linear portion 256a of the first driven node guide region L1, and the outer ring-side cage ring 220 maintains a state of being positioned at the first axial position P1 (region B, region C in FIG. 26). On the other hand, the second driven element 275 is guided along the first inclined portion 257b of the second driven node guide region L2, and the second driven node 270 and the inner ring-side cage ring 230 connected thereto move axially forward (region B in FIG. 26). Thereafter, the second driven element 275 is guided along the second linear portion 257c, whereby the inner ring-side cage ring 220 is positioned at the second axial position P2 (region C in FIG. 26).

At this time, a leg portion of the second cam 110b is pressed by the action of the second opening width variation portion 135b in the second cam holding portion 134 of the inner ring-side cage ring 230, and thereby the second cam 110b is inclined in the engagement release direction and changed to an idling posture. Since the first cam holding portion 133 of the inner ring-side cage ring 230 is formed in a rectangular shape with a constant opening width in the axial direction, the posture of the first cam 110a keeps an idling posture.

Accordingly, the operation mode of the selectable clutch 200 is switched from the reverse rotation direction lock mode (ModeB1) to a bi-directional free mode (ModeB2) that allows for relative rotation of the outer ring 101 and the inner ring 105 in both the normal and reverse rotation directions.

When the cylindrical cam 251 is further rotated in the normal rotation direction, the first driven element 265 is guided along the first inclined portion 256b of the first driven node guide region L1, and the first driven node 260 and the outer ring-side cage ring 220 connected thereto move axially forward (region D in FIG. 26). Thereafter, the first driven element 265 is guided along the second linear portion 256c, whereby the outer ring-side cage ring 220 is positioned at the second axial position P2 (region E in FIG. 26). On the other hand, the second driven element 275 is guided along the second linear portion 257c of the second driven node guide region L2, and the inner ring-side cage ring 230 maintains a state of being positioned at the second axial position P2 (region D, region E in FIG. 26).

At this time, a head portion of the first cam 110a is pressed by the action of the second opening width variation portion 124b in the first cam holding portion 123 of the outer ring-side cage ring 220, and thereby the first cam 110a is inclined in the engagement direction and changed to the engagement standby posture. Since the second cam holding portion 125 in the outer ring-side cage ring 220 is formed in a rectangular shape with a constant opening width in the axial direction, the posture of the second cam 110b holds an idling posture.

Accordingly, the operation mode of the selectable clutch 200 is switched from the bi-directional free mode (ModeB2) to a normal rotation direction lock mode (ModeB3) for inhibiting the relative rotation of the inner ring 105 in the normal rotation direction relative to the outer ring 101.

When the cylindrical cam 251 is further rotated in the normal rotation direction, the first driven element 265 is guided along the second linear portion 256c of the first driven node guide region L1, and the outer ring-side cage ring 220 maintains a state of being positioned at the second axial position P2 (region F, region G in FIG. 26). On the other hand, the second driven element 275 is guided along the second inclined portion 257d of the second driven node guide region L2, and the second driven node 270 and the inner ring-side cage ring 230 connected thereto move axially backward (region F in FIG. 26). Thereafter, the second driven element 275 is guided along the third linear portion 257e, whereby the inner ring-side cage ring 230 is positioned at the first axial position P1 (region G in FIG. 26).

At this time, the leg portion of the second cam 110b is pressed by the action of the second opening width variation portion 135b in the second cam holding portion 134 of the inner ring-side cage ring 230, and thereby the second cam 110b is inclined in the engagement direction and changed to the engagement standby posture. Since the first cam holding portion 133 of the inner ring-side cage ring 230 is formed in a rectangular shape with a constant opening width in the axial direction, the posture of the first cam 110a holds the engagement position.

Accordingly, the operation mode of the selectable clutch 200 is switched from the normal rotation direction lock mode (ModeB3) to a bi-directional lock mode (ModeB4) that inhibits relative rotation of the outer ring 101 and the inner ring 105 in both the normal and reverse rotation directions.

The selectable clutch according to the second embodiment is also not limited to the one configured to be capable of switching between four operation modes, and may be configured to be capable of switching between three operation modes, such as the bi-directional lock mode, the bi-directional free mode, and the normal rotation direction lock mode or reverse rotation direction lock mode.

Although the embodiments of the present invention have been described in detail above, the present invention is not limited to the above-described embodiments, and various modifications in design may be made without departing from the present inventions as defined in the claims.

Although the above embodiments has described a configuration in which the operation mode of the selectable clutch is the reverse rotation direction lock mode when the outer ring-side cage ring and the inner ring-side cage ring are positioned in the first axial position, the relationship between the operation mode of the selectable clutch and the axial positions of the outer ring-side cage ring and the inner ring-side cage ring is not particularly limited. For example, a configuration may be possible in which, when the outer ring-side cage ring and the inner ring-side cage ring are positioned in the first axial position, the operation mode of the selectable clutch is the normal rotation direction lock mode, the bi-direction lock mode, or the reverse rotation direction lock mode.

### REFERENCE SIGNS LIST

100, 200 Selectable clutch
101 Outer ring
102 Outer ring raceway surface
105 Inner ring
106 Inner ring raceway surface
110 Cam
110a First cam
110b Second cam
115 Biasing means
120, 220 Outer ring-side cage ring
121, 221 Body portion
122, 222 Outer flange portion
222a Recessed groove
123 First cam holding portion
123a Guide space portion
123b First posture fixing space portion
123c Second posture fixing space portion
124a First opening width variation portion
124b Second opening width variation portion
125 Second cam holding portion
126 Inner surface groove portion
127 Guide groove portion
128 Slide groove portion
130, 230 Inner ring-side cage ring
131, 231 Body portion
132 Inner flange portion
133 First cam holding portion
134 Second cam holding portion
134a Guide space portion
134b First posture fixing space portion
134c Second posture fixing space portion
135a First opening width variation portion
135b Second opening width variation portion
136 Outer surface groove portion
137 Guide groove portion
138 Slide groove portion
239 Outer flange portion
239a Recessed groove
140 Position regulating cage ring
141 Annular portion
142 Connecting portion
143 Pocket portion
145 Outward protrusion
146 Inward protrusion
150, 250 Switching mechanism
151, 251 Cylindrical cam
152 Shaft portion
153 Outer flange portion
155, 255 Cam groove
156a, 256a First linear portion
156b, 256b First inclined portion
156c, 256c Second linear portion
157a, 257a First linear portion
157b, 257b First inclined portion
157c, 257c Second linear portion
157d, 257d Second inclined portion
157e, 257e Third linear portion
160, 260 First driven node
161 Base body portion
162 Recess
163 Circumferential wall portion
164 Outer tooth
165, 265 First driven element
266 Engaging portion
267 Arm portion
268 Bearing portion
269 Cylindrical cam insertion hole
170, 270 Second driven node
171 Base body portion
172 Extension portion
173 Inner tooth
175, 275 Second driven element
180 Case
181 Outer cylindrical portion
182 Inner tooth
185 Inner cylindrical portion
186 Outer tooth
187 Notch
190 Snap ring
191 Snap ring
C1 Rotation axis center
C2 Rotational drive shaft
L1 First driven node guide region
L2 Second driven node guide region

1. A selectable clutch, comprising a switching mechanism for changing an operation mode by forcing one or both of a first cam and a second cam to incline, the first cam and the second cam having different engagement directions with respect to an outer ring and an inner ring and being held by an outer ring-side cage ring and an inner ring-side cage ring provided between the outer ring and the inner ring, wherein,
the outer ring-side cage ring and the inner ring-side cage ring are provided so as to be movable in an axial direction between a first axial position and a second axial position,
the outer ring-side cage ring is configured to be moved between the first axial position and the second axial position so that a posture of the first cam can be changed between an engagement standby posture and an idling posture in which the first cam is inclined to separate from the inner ring or the outer ring,
the inner ring-side cage ring is configured to be moved between the first axial position and the second axial position so that a posture of the second cam can be changed between an engagement standby posture and an idling posture in which the second cam is inclined to separate from the inner ring or the outer ring,
the switching mechanism includes a cylindrical cam having a cam groove formed on a circumferential surface thereof, and a first driven node and a second driven node coupled to the cylindrical cam, the first driven node being connected to the outer ring-side cage ring, and the second driven node being connected to the inner ring-side cage ring, and
the cam groove has a first driven node guide region including an inclined portion that moves the first driven node in the axial direction and a second driven node guide region including an inclined portion that moves the second driven node in the axial direction, one of the first driven node guide region and the second driven node guide region including an inclined portion that is shifted in phase in the circumferential direction with respect to an inclined portion of the other region.

2. The selectable clutch according to claim 1, wherein
the cylindrical cam has the cam groove formed on a circumferential surface of a cylindrical member,
the first driven node is an annular body in which a first driven element engaged with the cam groove is arranged so as to protrude radially inwardly from an inner circumferential surface,
the second driven node is an annular body in which a second driven element engaged with the cam groove is arranged so as to protrude radially outwardly from an outer circumferential surface, and
the cylindrical cam, the first driven node, and the second driven node are arranged coaxially with the outer ring and the inner ring.

3. The selectable clutch according to claim 1, wherein
the cylindrical cam is formed with the first driven node guide region and the second driven node guide region at positions spaced apart in the axial direction on a circumferential surface of a cylindrical member, and
the cylindrical cam is arranged on an axis extending parallel to rotation axis centers of the inner ring and the outer ring.

4. The selectable clutch according to claim 2, wherein
the switching mechanism includes a case that houses the cylindrical cam, the first driven node, and the second driven node,
the case having a detent that inhibits the first driven node and the second driven node from rotating together with the cylindrical cam.

5. The selectable clutch according to claim 1, wherein a position regulating cage ring that regulates a degree of freedom in circumferential movement of the outer ring-side cage ring and the inner ring-side cage ring is arranged between the outer ring-side cage ring and the inner ring-side cage ring.

6. The selectable clutch according to claim 5, wherein
the outer ring-side cage ring has an inner surface groove portion extending in the axial direction on an inner surface thereof,
the inner ring-side cage ring has an outer surface groove portion extending in the axial direction on an outer surface thereof,
the position regulating cage ring having an outward protrusion that is provided at one axial end so as to protrude radially outwardly and that is slidably engaged with the inner surface groove portion of the outer ring-side cage ring, and an inward protrusion that is provided at the other axial end so as to protrude radially inwardly and that is slidably engaged with the outer surface groove portion of the inner ring-side cage ring.
